(19) United States
(12) Patent Application Publication
(10) Pub. No.: US 2026/0210232 A1
(43) Pub. Date: Jul. 23, 2026

(54) SYSTEMS FOR AND METHODS OF BACKSPIN ANALYSIS FOR PUMPS

(71) Applicant: Sensia Netherlands B.V., Rotterdam (NL)

(72) Inventors: Jonathan Wun Shiung Chong, Calgary (CA); Jeffery Anderson, Beaumont (CA); Rongzhen Jin, Houston, TX (US); Albert Hoefel, Sugar Land, TX (US)

(73) Assignee: Sensia Netherlands B.V., Rotterdam (NL)

(21) Appl. No.: 19/364,049

(22) Filed: Oct. 21, 2025

Related U.S. Application Data
(60) Provisional application No. 63/748,687, filed on Jan. 23, 2025.

(51) Int. Cl. E21B 47/008; F04C 14/28

(52) U.S. Cl. CPC E21B 47/008; F04C 14/28

(57) ABSTRACT

Systems and methods for monitoring operation of an electric submersible pump or progressive cavity pump can use a backspin profile. The methods and systems can include receiving data signals indicating values for parameters regarding operation of the electric submersible pumping system during backspin and a backspin profile. One or more backspin profiles can be used to detect a failure, event, or condition associated with the pump system or a condition of a fluid associated with the pump system.

### CROSS-REFERENCE TO RELATED PATENT APPLICATIONS

This application claims the benefit of and priority to Provisional Application U.S. Application 63/748687, filed Jan. 23, 2025, incorporated herein by reference in its entirety.

### BACKGROUND

Pumps, such as electric submersible pumps (ESPs) and progressive cavity pumps (CPPs) may be deployed for any of a variety of pumping purposes, and often include a submersible pump powered by a submersible motor which is protected by a motor protector. For example, where a substance (e.g., hydrocarbons in an earthen formation) does not readily flow responsive to existing natural forces, an ESP may be implemented to artificially lift the substance. If an ESP fails during operation, the ESP must be removed from the pumping environment and replaced or repaired, either of which results in a significant cost to an operator.

In various applications, sensors or other detectors are used to detect pumping system failure and to output a warning regarding pumping system failure. Additionally, some well-related pumping applications employ sensors to monitor aspects of the pumping system operation, and surveillance engineers are employed to monitor the data and to make decisions regarding pumping system operation based on that data. However, such techniques may not address pumping system issues soon enough and may be subject to errors.

### SUMMARY OF THE INVENTION

Some embodiments of the present disclosure are directed to a method of monitoring operation of equipment of a pump system. The method includes receiving, by a processor from at least one sensor, a parameter during backspin operation of the pump system, and providing a backspin profile using the parameter.

In some embodiments, the method also includes using the backspin profile detect a failure, event, or condition associated with the pump system or a condition of a fluid associated with the pump system. In some embodiments, the method also includes using a set of backspin profiles to detect a failure, event, or condition associated with the pump system or a condition of a fluid associated with the pump system.

In some embodiments, the parameter includes a voltage signal. In some embodiments, the method also includes automatically adjusting operation of the pump system upon detecting the event.

In some embodiments, the backspin profile includes data representing speed over time. In some embodiments, the speed is represented by a frequency value. In some embodiments, the condition is wear associated with a pump component. In some embodiments, the parameter includes one or more of the group of: a drive frequency of an electric submersible pump, a motor current of the electric submersible pump, a discharge pressure of the electric submersible pump, an intake pressure of the electric submersible pump, a motor temperature of the electric submersible pump, an intake temperature of the electric submersible pump, a well head pressure, and one or more current parameters of a gauge of the electric submersible pump.

Some embodiments of the present disclosure are directed to system for monitoring operation of an electric submersible pump system. The system for monitoring includes at least one sensor configured to generate a parameter regarding operation of the electric submersible pump system and a processor. The processor is in communication with the sensor and configured to: receive the parameter from the sensor during backspin operation of the pump system and provide a backspin profile using the parameter.

In some embodiments, the backspin profile provides an indication of backspin duration, linearity of speed change, and/or a maximum backspeed. In some embodiments, the processor is further configured to use a set of backspin profiles to detect a failure, event, or condition associated with the pump system or a condition of a fluid associated with the pump system. In some embodiments, the pump system includes an electric submersible pump or progressive cavity pump. In some embodiments, the processor is further configured to adjust operation of the electric submersible pumping system upon detecting the event, condition, or fault. In some embodiments, the processor is part of a pump system controller. In some embodiments, the processor is part of a remote server. In some embodiments, the pump system includes an electric submersible pump and the parameter includes one or more of the group of: a drive frequency of the electric submersible pump, a motor current of the electric submersible pump, a discharge pressure of the electric submersible pump, an intake pressure of the electric submersible pump, a motor temperature of the electric submersible pump, an intake temperature of the electric submersible pump, a well head pressure, and one or more current parameters of a gauge of the electric submersible pump.

Some embodiments of the present disclosure are directed to a non-transitory computer-readable medium containing instructions. The instructions, when executed by a processor, cause the processor to determine a backspin speed during backspin operation of a pump system and provide a backspin profile using the backspin speed.

In some embodiments, the instructions further cause the processor to detect a failure, event, or condition associated with the pump system or a condition of a fluid associated with the pump system using the backspin profile. In some embodiments, the instructions further cause the processor to adjust operation of the pump system upon detecting the event, condition, or failure.

Other embodiments of the present disclosure are directed to a system for monitoring operation of an electric submersible pump. The system includes sensors to generate data indicative of a plurality of observable parameters regarding operation of the electric submersible pumping system and a processor coupled to the sensors. The processor is configured to receive the data from the sensors and generate an indication of an event, condition or fault based upon parameters occurring during backspin.

The foregoing has outlined rather broadly a selection of features of the disclosure such that the detailed description of the disclosure that follows may be better understood. This summary is not intended to identify key or essential features of the claimed subject matter, nor is it intended to be used as an aid in limiting the scope of the claimed subject matter.

### BRIEF DESCRIPTION OF THE DRAWINGS

Embodiments of the disclosure are described with reference to the following figures, wherein like reference numerals indicate like elements:

FIG. 1 is a side view, partial cross sectional view schematic drawing of an exemplary electric submersible pumping system deployed in a wellbore and including a backspin analyzer, according to an embodiment of the disclosure;

FIG. 2 is an illustration of a flow diagram of a method for monitoring operation of an electric submersible pumping system using a backspin profile, according to an embodiment of the disclosure;

FIG. 3 is a set of four graphs showing a representation of a backspin profile for the system illustrated in FIG. 1 according to an embodiment of the disclosure;

FIG. 4 is a set of three graphs showing representations of a backspin profile over a three month period for the system illustrated in FIG. 1 according to an embodiment of the disclosure;

FIG. 5 is a set of three graphs showing a representation of a backspin profile for the system illustrated in FIG. 1 over time according to an embodiment of the disclosure; and

FIG. 6 is a set of curves showing a duration parameter of a backspin profile for the system illustrated in FIG. 1 over time according to an embodiment of the disclosure.

### NOTATION AND NOMENCLATURE

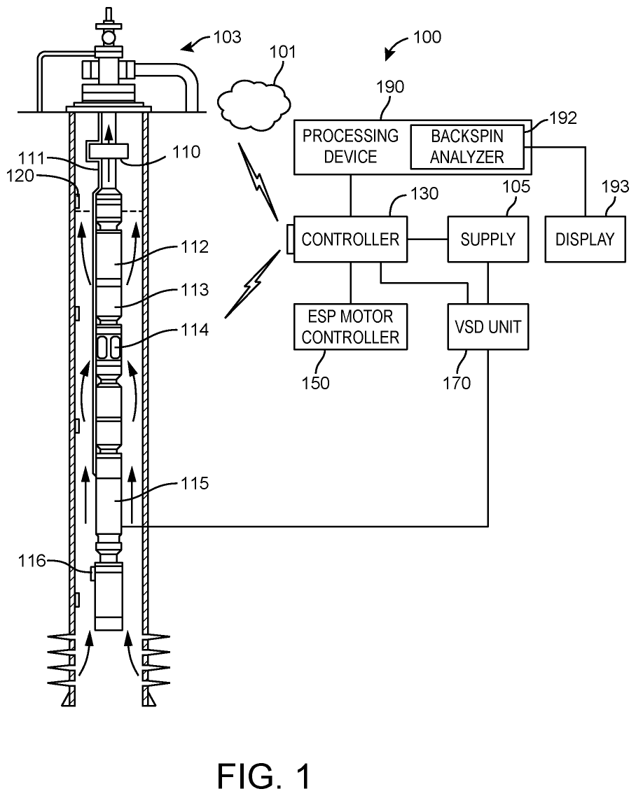

Various terms are used herein, which are defined as follows:
Channel: There may be multiple sensors placed at different locations as illustrated in FIG. 1. The set of measurements received from the same sensor is called a channel.

Amps is a measurement of drive current. This measurement represents the load of the pump.

Tₘ refers to motor temperature. This measurement represents the inside motor temperature.

Pᵢ refers to intake pressure. This measurement represents the pressure at the intake of the pump.

P_{d} refers to discharge pressure. This measurement represents the pressure at the discharge of the pump.

P_{i (static)} refers to a static pressure at the intake of the pump, or the pressure to which intake pressure Pᵢ reverts to when the pump is turned off.

f refers to frequency and, more specifically drive frequency in the context of the present disclosure. This measurement represents the speed of the motor (with minor reduction from electrical-to-mechanical rotation conversion or “slip”). f influences both P_{d} and Pᵢ; P_{d} increases proportionally with an increase in f while Pᵢ decreases proportionally with the increase in f.

t refers to time.

Q refers to fluid flow rate through the pump. This quantity indicates whether there is a low/no flow condition exists at the pump. Q depends on both the difference in reservoir and intake pressures (i.e., P_{i (static)}−Pᵢ) and the difference in discharge and intake pressures (i.e., P_{d}−Pᵢ).

ΔP refers to the difference in discharge and intake pressures (i.e., P_{d}−Pᵢ).

CLa refers to current leakage active. This value is measured when the pump is off and thus represents the condition of cable insulation and/or ESP system insulation. The leakage current is indicative of the health of the ESP motor cables and thus can be used to monitor ground faults, which result in inferior data quality when present.

Cf refers to a full calibration current. This value is mapped to the upper bounds of the gauge measurement capability.

Cz refers to a zero calibration current. This value is mapped to the lower bounds of the gauge measurement capability.

Tᵢ refers to ambient temperature at the intake of the pump.

WHP refers to wellhead pressure. This value is measured on the surface and represents the pressure before the choke. The WHP value may be highly proportional to choke position. For example, if an operator closes the choke, WHP increases and vice versa.

CDP refers to choke downstream pressure. This channel is measured on the surface and represents the pressure after the choke. When CDP is combined with WHP, the combination may represent the flow at the surface.

WHT refers to wellhead temperature. WHT is measured at the wellhead and affected by the fluid temperature inside the tubing and the ambient temperature outside the tubing.

Choke position refers to a measure of the choke, and is commonly given as an aperture percentage.

### DETAILED DESCRIPTION

One or more embodiments of the present disclosure are described below. These embodiments are merely examples of the presently disclosed techniques. Additionally, in an effort to provide a concise description of these embodiments, all features of an actual implementation may not be described in the specification. It should be appreciated that in the development of any such implementation, as in any engineering or design project, numerous implementation-specific decisions are made to achieve the developers'specific goals, such as compliance with system-related and business-related constraints, which may vary from one implementation to another. Moreover, it should be appreciated that such development efforts might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The embodiments discussed below are intended to be examples that are illustrative in nature and should not be construed to mean that the specific embodiments described herein are necessarily preferential in nature. Additionally, it should be understood that references to “one embodiment” or “an embodiment” within the present disclosure are not to be interpreted as excluding the existence of additional embodiments that also incorporate the recited features. The drawing figures are not necessarily to scale. Certain features and components disclosed herein may be shown exaggerated in scale or in somewhat schematic form, and some details of conventional elements may not be shown in the interest of clarity and conciseness.

The terms “including” and “comprising” are used herein, including in the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections. If the connection transfers electrical power or signals, the coupling may be through wires or other modes of transmission. In some of the figures, one or more components or aspects of a component may not displayed or may not have reference numerals identifying the features or components that are identified elsewhere in order to improve clarity and conciseness of the figure.

Electric submersible pumps (ESPs) and cavity progressive pumps (CVPs) may be deployed for any of a variety of pumping purposes. For example, where a substance does not readily flow responsive to existing natural forces, an ESP may be implemented to artificially lift the substance. Commercially available ESPs (such as the REDA™ ESPs marketed by Schlumberger Limited, Houston, Tex.) may find use in applications that require, for example, pump rates in excess of 4,000 barrels per day and lift of 12,000 feet or more.

To improve ESP operations, an ESP may include one or more sensors (e.g., gauges) that measure any of a variety of physical properties (e.g., voltage, current, temperature, pressure, vibration, etc.). A commercially available sensor is the Phoenix MultiSensor™ marketed by Schlumberger Limited (Houston, Tex.), which monitors intake and discharge pressures; intake, motor and discharge temperatures; and vibration and current leakage. A voltmeter or other signal analyzer can provide indications of voltages, currents and frequencies associated with an ESP or other motor containing component. An ESP monitoring system may include a supervisory control and data acquisition system (SCADA). Commercially available surveillance systems include the espWatcher™ and the LiftWatcher™ surveillance systems marketed by Schlumberger Limited (Houston, Tex.), which provides for communication of data, for example, between a production team and well/field data (e.g., with or without SCADA installations). Such a system may issue instructions to, for example, start, stop, or control ESP speed via an ESP controller.

The conventional method for detecting pumping system failures and generating warnings or alarms regarding pumping system failures may not address issues early enough and are subject to false alarms. Further, much of the evaluation (e.g., of alarms or warnings) is performed by surveillance engineers and thus is prone to error, delay, and inconsistency. As a result, certain errors may be miscategorized or overlooked, leading to ESP or CVP events going unnoticed. In the case where delay exists in identifying and/or categorizing an event, it may be too late to take any corrective action to remedy the ESP CVP issue.

To overcome these deficiencies of conventional ESP event detection, and in accordance with various embodiments of the present disclosure, systems and methods are described in that facilitate improvement of operations with respect to an ESP or CVP system deployed in a well environment or other environment. Some embodiments advantageously provide analysis of backspin characteristics to determine pump conditions, faults or events. Monitoring of backspin characteristics (e.g., a backspin profile) alone or in combination with other parameters can provide insight regarding operation of an ESP or PCP system. Based at least in part on the processing of data associated with the backspin characteristics, a specific event (or events) may be detected, which may indicate potential problems with operation of the ESP or CVP system. In some embodiments, automatic adjustment of the ESP or CVP system may be carried out in real time or near real time in response to detection of one or more faults, events, or conditions.

When an ESP or CVP is shut down, the fluid column in the tubing generally falls until the fluid is even with the casing fluid level, which results in a reverse spin of the pump and motor. When stopping the pumps rotation (e.g., shutting down the pump), frequency/speed quickly dips past zero, and towards the highest magnitude at a negative speed. After that, with a reduction of differential pressure across the pump, the ESP or CVP slows down following a profile curve before stopping at zero speed. The backspin (e.g., rotation at the negative speed) can be measured using electric signals (e.g., voltage signals) from the surface cables coupled to the motor of the ESP or PCP. Analysis of the voltage signals is used to determine the frequency (speed) of the ESP or PCP that are present throughout the backspin phenomenon (e.g., a backspin profile). In some embodiments, frequency of the signal is indicative of motor speed.

In some embodiments, the Automatic Event Detection (AED) algorithm may be used on a processor-based system, such as a computer system, to process data related to operation of an ESP or PCP. By way of example, the data may be obtained from surface and downhole measurements. In an embodiment, an ESP is installed downhole in a well where oil is available, and the ESP is used to lift oil from there to the surface. An ESP or PCP failure leads to cost of replacement and deferred production. As used in the description herein, an ESP or PCP event refers to a situation in which the ESP or PCP potentially can be damaged or is damaged. In some embodiments, systems and methods gather and analyze the backspin curve profiles over time to diagnose conditions of a well, its fluid, and/or the ESP and PCP.

Well conditions related to fluid viscosity can be determined using backspin curve profiles in some embodiments. As the fluid column becomes increasingly more viscous or solids laden, and other conditions are the same (e.g., the same pump), there is more resistance in the fluid against the ESP. Hence, the backspin profile that demonstrate a smaller magnitude of negative frequency, and/or different curve gradients towards 0 frequency indicate higher viscosity or more solids. The converse is true, the lesser the viscosity, the higher the magnitude of negative frequency. In some embodiments, backspin profile changes can be used to determine changing well fluid conditions. For example, a backspin profile that is relatively more jagged and imperfect can indicate presence of solids such as sand or other deposits. In another example, holes in the tubing which alter the differential pressure across the pump and alter the speed decay are manifested in the backspin profile.

ESP or PCP conditions related to wear can be determined using backspin curve profiles in some embodiments. For example, as the ESP string becomes more unstable due to pump wear, bearing damage, or other mechanical issues, a backspin profile that is relatively more jagged compared to a healthy ESP with a smooth backspin profile indicates such wear. The backspin profile that is relatively more jagged can indicate imbalance caused by friction or other imbalance some embodiments.

Analysis of backspin profiles over time can be used indicate wear over time wear. For example, a more gradual change indicates gradual wear as opposed to more instantaneous events. In some embodiment, changes in the shape and settling time in the backspin profile over time for the same volume of an equivalent fluid composition indicate increasing levels of wear in some embodiments. For example, the backspin settling time may become protracted as increased bearing friction in the ESP prevents the column of fluid from falling back down through the pump, and this time from the pumping stop to ~0 Hz pump rotation can be tracked as an informative metric over time. Pump blade erosion may have the opposite effect. Pump blade erosion can lead to reduced choking when back flow happens and therefore influence the duration of settlement to equal fluid levels. More generally, pump blade erosion could lead to higher or lower reverse flow rates depending on the influences of choking or free-spinning capability of the blades; these can be indicated by comparing the backspin profile to new healthy pumps.

In some embodiments, motor performance degradation can also be observed from the symmetry and magnitude of the electrical signals, that are used to estimate the backspin speed/frequency. Systems and methods may employ analysis in time and in the frequency domain, where wear may present itself in the form of low magnitude tones caused by the pump catching or binding in reverse rotation. These signal levels may be small and difficult to observe in an active powered system but are more detectable in the unpowered, backspinning state in some embodiments. In some embodiments, mechanical imbalance can be detected.

Various measurements may be used for the detection of the event and can be part of the backspin profile, and examples of those measurements include measurements of drive frequency, motor current, motor voltage, discharge pressure, intake pressure, motor speed/frequency, and motor temperature, which are explained in greater detail below. If additional measurements, such as measurements including derived parameters (e.g., from algorithms or modelling) or completion information (e.g., pump curves, inflow performance) are available, those measurements may be used to further enhance the event detection. However, the described event detection systems and methods are robust enough to function even in situations in which such additional measurements are not available in some embodiments.

In some applications, physics knowledge and contextual information also can provide helpful data which is useful in detecting and categorizing a particular event or events. The physics and contextual information may include a variety of information related to the oilfield and/or the ESP. For example, each ESP is designed differently and, therefore, has different physics properties. Information collected during field exploration and drilling processes also is helpful in establishing different baselines for different oilfields and different wells. By integrating this information into a mathematical model, the processing of data is facilitated with respect to event and condition detection and protection of the ESP.

Embodiments described herein may be used to detect an event or condition rather than a failure. The difference between an event and a failure is that often multiple events lead to a failure. Embodiments described herein also may utilize the AED to target a variety of different problems relative to existing systems. Additionally, embodiments described herein may combine the available channels to produce an improved detection result.

Referring now to FIG. 1, an example of an ESP system 100 is shown. The ESP system 100 includes a network 101, a well 103 disposed in a geologic environment, a power supply 105, an ESP 110, a controller 130, a motor controller 150, and a variable speed drive (VSD) unit 170. The power supply 105 may receive power from a power grid, an onsite generator (e.g., a natural gas driven turbine), or other source. The power supply 105 may supply a voltage, for example, of about 4.16 kV. The descriptions below related to ESP 110 apply to a PCP in some embodiments.

The well 103 includes a wellhead that can include a choke (e.g., a choke valve). For example, the well 103 can include a choke valve to control various operations such as to reduce pressure of a fluid from high pressure in a closed wellbore to atmospheric pressure. Adjustable choke valves can include valves constructed to resist wear due to high velocity, solids-laden fluid flowing by restricting or sealing elements. A wellhead may include one or more sensors such as a temperature sensor, a pressure sensor, a solids sensor, and the like.

The ESP 110 includes cables 111, a pump 112, gas handling features 113, a pump intake 114, a motor 115 and one or more sensors 116 (e.g., frequency, voltage, current, temperature, pressure, current leakage, vibration, etc.). The well 103 may include one or more well sensors 120, for example, such as the commercially available OpticLine™ sensors or WellWatcher BriteBlue™ sensors marketed by Schlumberger Limited (Houston, Tex.). Such sensors are fiber-optic based and can provide for real time sensing of downhole conditions. Measurements of downhole conditions along the length of the well can provide for feedback, for example, to understand the operating mode or health of an ESP. Well sensors may extend thousands of feet into a well (e.g., 4,000 feet or more) and beyond a position of an ESP.

The controller 130 can include one or more interfaces, for example, for receipt, transmission or receipt and transmission of information with the motor controller 150, a VSD unit 170, the power supply 105 (e.g., a gas fueled turbine generator or a power company), the network 101, equipment in the well 103, equipment in another well, and the like. The controller 130 may also include features of an ESP motor controller and optionally supplant the ESP motor controller 150.

The motor controller 150 may be a commercially available motor controller such as the UniConn™ motor controller marketed by Schlumberger Limited (Houston, Tex.). The UniConn™ motor controller can connect to a SCADA system, the espWatcher™ surveillance system, etc. The UniConn™ motor controller can perform some control and data acquisition tasks for ESPs, surface pumps, or other monitored wells. The UniConn™ motor controller can interface with the Phoenix™ monitoring system, for example, to access pressure, temperature, and vibration data and various protection parameters as well as to provide direct current power to downhole sensors. The UniConn™ motor controller can interface with fixed speed drive (FSD) controllers or a VSD unit, for example, such as the VSD unit 170.

In accordance with various examples of the present disclosure, the controller 130 may include or be coupled to a processing device 190. Thus, the processing device 190 is able to receive data from ESP sensors 116 and/or well sensors 120. Although shown schematically at certain locations, it should be appreciated that the ESP sensors 116 and/or well sensors 120 may be situated in various locations among the system 100. These sensors 116, 120 may be used to measure various parameters disclosed above, such as voltage, current, frequency, motor speed, drive current, motor temperature, pump intake pressure, pump discharge pressure, static intake pressure, drive frequency, pump flow rate, and the like.

As will be explained in further detail below, the processing device 190 analyzes the data received from the sensors 116 and/or 120, possibly with the addition of sensors from the VSD unit 170 and the controller 130, to provide enhanced and automated event, fault and/or condition detection, which may then be used to control the operation of the ESP 110 to prolong its life and/or avoid downtime of the ESP 110. The detection of an event associated with ESP 110 may be presented to a user such as a surveillance center employee or a well site operator through a display device (not shown) coupled to the processing device 190, through a user device (not shown) coupled to the network 101, or other similar manners. Generally, the processing device 190 may also be referred to as executing an AED engine to carry out various functionality of that engine described herein. The scope of the present disclosure is not intended to be limited to any particular location of various system 100 components; for example, processing and event, condition, and/or fault detection may be carried out at the well site, in a cloud environment; at a remote surveillance center, and in any number of various centralized and distributed arrangements.

Processing system and/or controller 130 can include a backspin analyzer 192. Backspin analyzer 192 can be a software module configured to detect a backspin event and generate a backspin profile. Backspin analyzer 192 can include communication circuitry, processing devices, and interface devices for receiving and processing the various measurements and data described herein. The backspin profile can be provided to a display 193. Backspin analyzer 192 is configured to provide indications of fluid conditions or pump conditions (e.g., wear, event, or failure) in real time and over time in some embodiments. Backspin analyzer 192 can be part of an AED engine.

In some embodiments, backspin analyzer 192 can compare the backspin profile to a database of profiles for a similar ESP 110. The profiles in the database can be associated with a particular event, condition, or failure based upon prior observations. Pattern matching solutions are used to diagnose the event, condition or event based upon the sensed profile and the match. Other data can also be used to make the match including but not limited to motor temperature, motor current, pump type, well history, differential pressure across ESP 110, fluid viscosity, pump age, any of the values defined in this disclosures, etc. In some embodiments, trends in profiles over time can be matched to profile trends in a database associated with events, conditions, and failures.

Backspin analyzer 192 can employ artificial intelligence techniques. In some embodiments, a mathematical curve fit (e.g., polynomial) is trained to provide backspin profile analysis. In some embodiments, a machine learning model (e.g., neural network) with ideal/reference backspins can be used to contrast with progressively degraded/anomalous profiles. Backspin analyzer 192 can be used to classify different types of issues based on backspin curve profiles, for example using a labelled dataset and a machine learning classifier to differentiate between impeller wear vs. bearing wear in some embodiments. Various classifier approaches working on either the time-series data or shape/image recognition can be employed.

In some embodiments, backspin analyzer 192 takes into account changes occurring over time. For example, the evolution of settling time over time (or incrementing shutdowns) can provide further differentiation between types of issues. In some embodiments, the analysis may also include conditional checks to ensure comparisons are performed for equivalent volumes and compositions of fluid in the tubing. For example, a backspin may only be included in the analysis if a combination of conditions have been satisfied (e.g., pump has been running more than a specific amount of time and/or the downhole pressure (e.g., intake and discharge pressure) has stabilized). In some embodiments, when casing fluid level and tubing fluid level reach equilibrium and the pump stops spinning, backspin analyzer 192 can determine if there has been no detection of a gas interference in a preceding amount of time.

In some embodiments, the analysis may be further enhanced with high temporal resolution data, for example at the second or 100 ms level to capture more subtle or short-lived non-linearities and to increase the time precision on time-to-peak-reverse-speed and time-to-be-stopped. Local or edge based processing on a computing platform local to the electrical data acquisition system can be used by backspin analyzer 192 to enable higher data volumes to be efficiently processed without requiring remote connectivity or cloud computing resources.

Backspin analyzer 192 can use diagnoses or detected conditions to recommend actions. The recommended actions include but are not limited to: adjusting (reducing) ESP speed during normal operation to prevent further pulling in of solids from the wellbore, flushing the well if solids are confirmed, to prevent further wear and damage to the ESP, at the next startup, adjusting choke, early stalling detection and mitigation with rocking start when slow speed settling has been observed in the previous shut down, initiating any stuck pump control routines (such as rapid reverse spin) to dislodge solids and clear the solids, and/or plan for a workover to replace ESP 110 if conditions are too severe to remedy.

In some embodiments, the network 101 comprises a cellular network and the user device is a mobile phone, a smartphone, or the like. In these embodiments, the detection of an event of the ESP 110 may be transmitted to one or more users physically remote from the ESP system 100 over the network 101 (e.g., cellular). In some embodiments, the detection of an event of the ESP 110 may indicate that the ESP 110 is expected to remain in its normal operating mode, or may be a warning of varying severity that a fault, failure, or degradation in ESP 110 performance is expected.

Regardless of the type of ESP 110 event or condition detected, certain embodiments of the present disclosure may include taking a remedial or other corrective action in response to detection of an event that may lead to a decrease in ESP 110 performance or to an outright failure of the ESP 110. The action taken may be automated in some instances, such that detection of a particular type of event automatically results in the action being carried out. Actions taken may include altering ESP 110 operating parameters (e.g., operating frequency) or surface process parameters (e.g., choke or control valves) to prolong ESP 110 operational life, stopping the ESP 110 temporarily, and providing a warning to a local operator, control room, or a regional surveillance center.

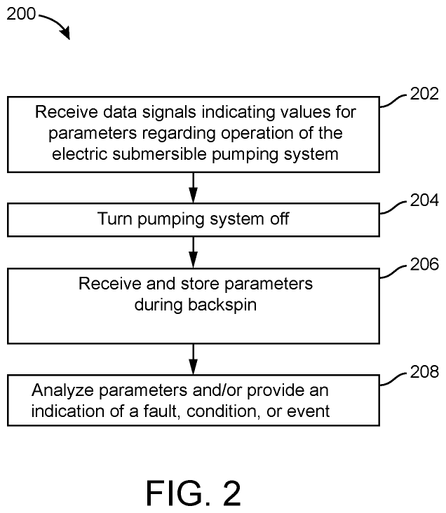

With reference to FIG. 2, a flow 200 can be used by processing system or device 190 or controller 130 to determine conditions of the well or ESP 110 (FIG. 1). In an operation 202, data signals are received related to operations of an operating ESP 110. The signals can include but are not limited to signals or data representing drive frequency, motor voltage, motor current, discharge pressure, intake pressure, motor speed/frequency, motor temperature, etc. In an operation 204, ESP 110 is turned off (e.g., electric energy is not provided to the motor from controller 150). In some embodiments, ESP 110 is operated at a steady state before being shut down. The steady state can be sensed by measuring a consistent frequency for a period of time (e.g., 30 minutes, an hour, etc.). In some embodiments, the static pressure or differential pressure is measured before the ESP 110 system is turned off and used in the analysis. In some embodiments, the fluid flow is measured before the ESP system 100 is turned off and used in the analysis.

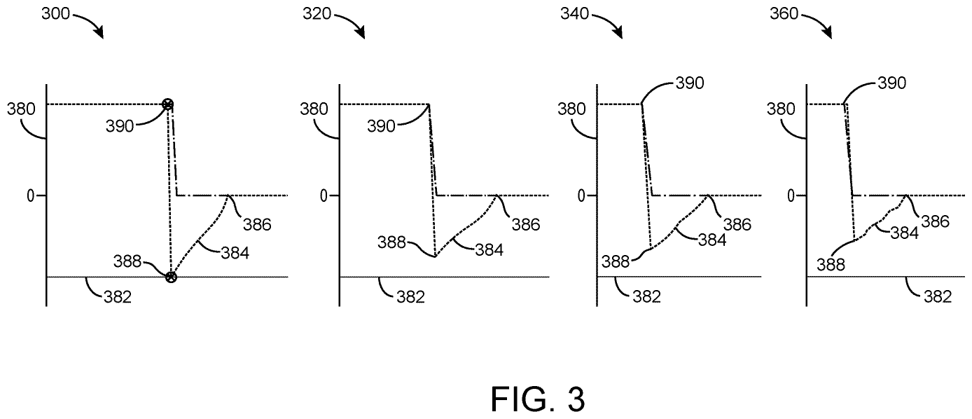

In an operation 206, parameters occurring during backspin are received and stored. The parameters can be stored by backspin analyzer 192. The parameters can include but are not limited to signals or data representing motor voltage, drive frequency, motor current, discharge pressure, intake pressure, motor speed/frequency, motor temperature, etc. In an operation 208, the parameters are analyzed. The parameters can be provided in a graph format over time (e.g., see FIGS. 3-6). The analysis can include the determination of settling time (e.g., the time between turning off the ESP 110 and reaching zero speed after the backspin as begun), peak reverse rotational speed (frequency), average reverse rotational speed, the time between drive-off to the peak reverse rotational speed, the linearity/non-linearity of the reverse rotational speed, and/or comparison to previous profiles. Overlaying of backspin curve profiles, normalized to frequency and time, can be used to visually compare progression from healthy/normal to damaged/abnormal and to automatically predict a wear state, well condition, event, and/or fault.

With reference to FIG. 3, four exemplary graphs 300, 320, 340, and 360 represent four backspin profiles for an ESP 110 over time. The data for graphs 300, 320, 340, and 360 as well as graphs 300, 320, 340, and 360 can be provided by backspin analyzer 192. Graphs 300, 320, 340, and 360 are each provided on a y axis 380 representing frequency of the voltage signal at the motor terminals and an x axis 382 representing time. Each of graphs 300, 320, 340, and 360 taken at different shutdowns (in a time sequence over weeks). The profiles of graphs 300 and 320 are relatively smooth and indicate normal backspin, and graphs 340 and 360 progressively become jagged and imperfect at a portion 384 between zero frequency point 386 (e.g., pump stoppage) and lowest negative frequency point 388 (e.g., maximum backspin speed). Graph 340 indicates presence solids and/or mechanical damage. Graph 340 indicates presence of more solids and/or mechanical damage. A point 390 indicates a time when ESP 110 is turned off (e.g., frequency when ESP 110 is turned off). A time between point 390 and point 388 indicates a time between shut down and maximum reverse speed. The times and frequencies discussed above can be used for condition analysis by backspin analyzer 192.

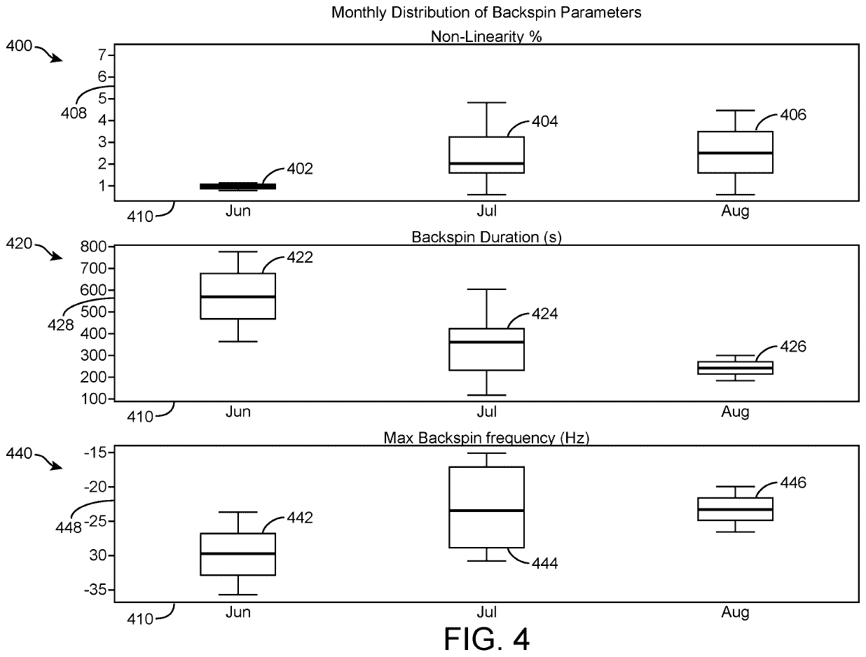

With reference to FIG. 4, three exemplary graphs 400, 420, and 440 represent for backspin parameters over a three month period represented by x axis 410. Graph 400 includes a y axis 408 representing percentage of non-linearity of the backspin profile (e.g., of portion 384 (FIG. 3)). Graph 420 includes a y axis 428 representing backspin duration in time (e.g., between points 388 and 386 (FIG. 3)) of the backspin profile. Graph 440 includes a y axis 448 representing maximum backspin frequency in hertz (Hz) (e.g., point 388 (FIG. 3)) of the backspin profile.

The data for graphs 400, 420, and 440 as well as graphs 400, 420, and 440 can be provided by backspin analyzer 192. Graph 400 includes representations 402, 404 and 406 that increase over three months. Graph 420 includes representations 422, 424 and 426 of back speed duration that decrease over three months. Graph 440 includes representations 442, 444 and 446 of maximum back speed duration that is highest the second month and lowest in the first month. Representations 402, 404, 406, 422, 424, 426, 442, 444, and 446 represent distributions of the parameter over the month with an average represented by a line within the box and the outline of the box representing minimum and maximum values.

Generally, settling time and max (negative) backspin frequency are a function of multiple factors such as: operating/control modes, operating frequency at moment of ESP shutdown, fluid properties, degree of normal wear/degradation, etc. Non-linearity or smoothness is a more direct indicator of imbalance or abnormal friction due to solids stuck in the pump or localized damage in bearings in some embodiments.

In some embodiments, graph 400 shows changes in the non-linearity or smoothness with a clear rise in the second month compared to the first month (e.g., of install) which indicate challenges to get the ESP 110 to pump smoothly due to solids ingestion and onset of damage. In the third month, operations were able to clear some of these solids through control actions and improve the spread of non-linearity, but generally levels remain elevated compared to first month due to a combination of (a lesser degree) or solids ingestion and irreversible or onset of damage.

In some embodiments, graph 440 shows a clear pattern of decreasing magnitude from the first month to the third month which may be due to increased friction from solids and onset of damage—when the fluid column drops, the pump is less free to spin.

In some embodiments, graph 420 shows settling times are reduced from the first month to the third month which is consistent with max backspin frequency and its diagnosis.

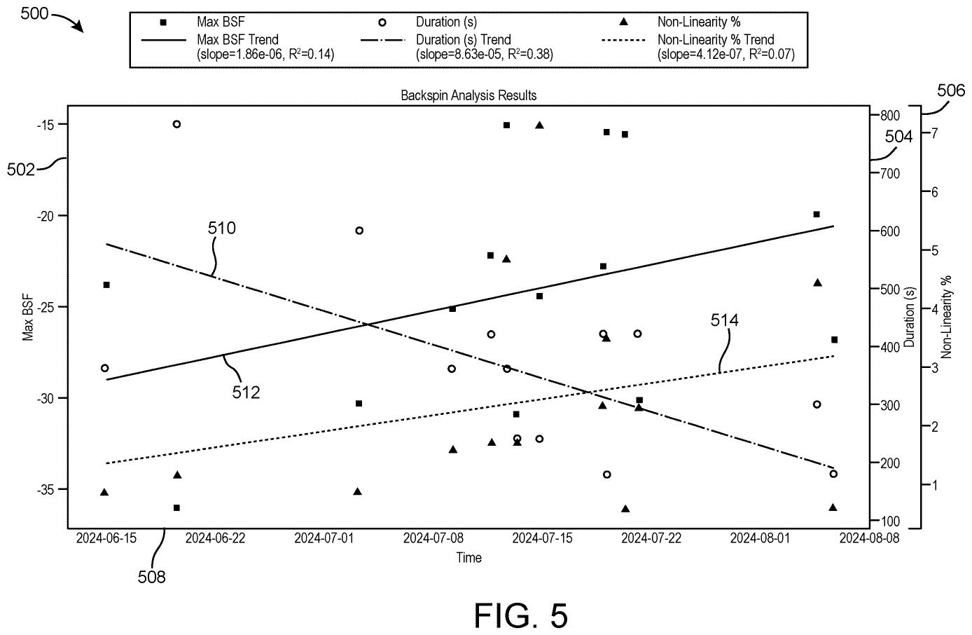

With reference to FIG. 5, a graph 500 includes a y axis 502 representing maximum back speed in frequency, a y axis 504 representing duration in seconds, and a y axis representing non-linearity in percentage. An x axis 508 represents time. A curve 510 shows nonlinearity over time. A curve 512 shows max backspin speed over time. A curve 520 shows duration over time. Curves 510, 512 and 514 can be provided by backspin analyzer 192.

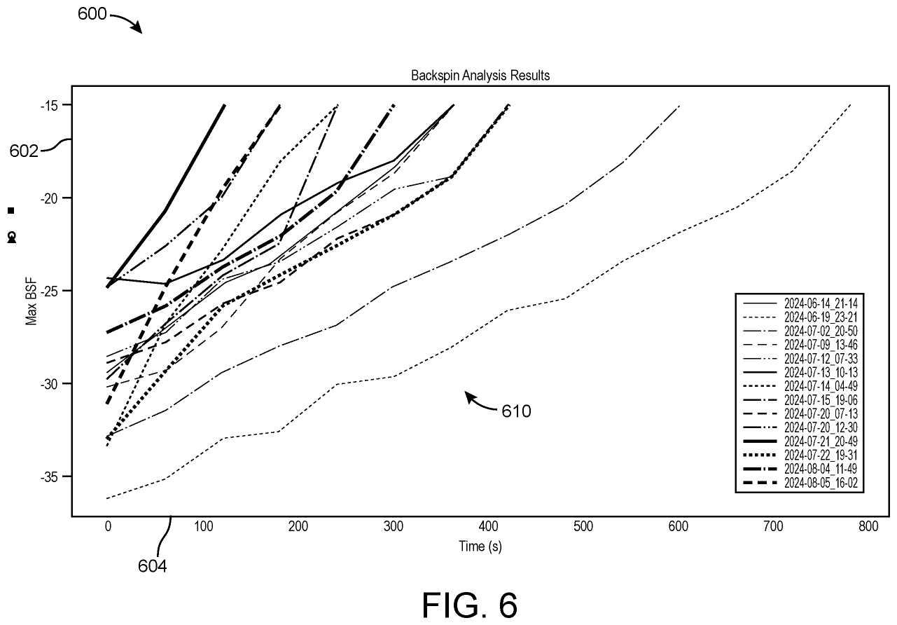

With reference to FIG. 6, a graph 600 includes a y axis 602 representing frequency an x axis 604 represents time. Curves 610 show speed over time during backspin. Each curve of curves 610 was taken at a different time and the set of curves 610 shows changes in maximum backspin speed, non-linearities, and backspin duration over a number of samples different times. Curves 610 can be provided by backspin analyzer 192.

As described herein, systems and methods for condition detection may be applied at selected ESP well applications where certain parameter measurements (e.g., by way of sensors 116, 120 (FIG. 1)) are available. Examples of those measurements include drive frequency, motor voltage, motor current, discharge pressure, intake pressure, and motor temperature, as discussed above. Applications may include offshore wells in which the parameter measurements are available and protection of the ESP is very important, for example due to cost considerations as explained above.

In certain cases, each of a number of measurement channels may have the same sampling frequency and the same starting time. However, often times in reality, each channel may have its own sampling frequency its own starting time. Further, the sampling rate may be changed during operation, for example due to operator intervention. As a result, certain data may be missing and examples of the present disclosure pre-process the data to achieve a complete dataset. First, for example, a same sampling rate is applied to the whole dataset (i.e., the data from a number of different measurement channels). If the actual sampling rate is under-sampling for a specific channel, then a linear regression model may be applied to impute the missing values. On the other hand, if the actual sampling rate is over-sampling, then a moving average window may be applied to down-sample the channel. That is, in the event data needs to be re-sampled, regardless of whether it is to up-or down-sample, such re-sampling may be carried out.

Some of the methods and processes described above, including processes, as listed above, can be performed by a processor (e.g., processing device 190). The term “processor” should not be construed to limit the embodiments disclosed herein to any particular device type or system. The processor may include a computer system. The computer system may also include a computer processor (e.g., a microprocessor, microcontroller, digital signal processor, server, or general purpose computer) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described above, as listed above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Although only a few example embodiments have been described in detail above, those skilled in the art will readily appreciate that many modifications are possible in the example embodiments without materially departing from the scope of the present disclosure. Features shown in individual embodiments referred to above may be used together in combinations other than those which have been shown and described specifically. Accordingly, all such modifications are intended to be included within the scope of this disclosure as defined in the following claims.

The embodiments described herein are examples only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims.

What is claimed is:

1. A method for monitoring operation of equipment of a pump system, comprising:
receiving, by a processor from at least one sensor, a parameter during backspin operation of the pump system; and
providing a backspin profile using the parameter.

2. The method of claim 1, further comprising:
using the backspin profile detect a failure, event, or condition associated with the pump system or a condition of a fluid associated with the pump system.

3. The method of claim 1, further comprising:
using a set of backspin profiles to detect a failure, event, or condition associated with the pump system or a condition of a fluid associated with the pump system.

4. The method of claim 3, wherein the parameter comprises a voltage signal.

5. The method of claim 2, further comprising automatically adjusting operation of the pump system upon detecting the event.

6. The method of claim 1, wherein the backspin profile comprises data representing speed over time.

7. The method of claim 6, wherein the speed is represented by a frequency value.

8. The method of claim 2, wherein the condition is wear associated with a pump component.

9. The method of claim 1 wherein the parameter comprises one or more of the group consisting of: a drive frequency of an electric submersible pump, a motor current of the electric submersible pump, a discharge pressure of the electric submersible pump, an intake pressure of the electric submersible pump, a motor temperature of the electric submersible pump, an intake temperature of the electric submersible pump, a well head pressure, and one or more current parameters of a gauge of the electric submersible pump.

10. A system for monitoring operation of an electric submersible pump system, the system for monitoring comprising:
at least one sensor configured to generate a parameter regarding operation of the electric submersible pump system;
a processor in communication with the sensor and configured to:
receive the parameter from the sensor during backspin operation of the pump system; and
provide a backspin profile using the parameter.

11. The system for monitoring of claim 10, wherein the backspin profile provides an indication of backspin duration, linearity of speed change and a maximum backspeed.

12. The system for monitoring of claim 10, wherein the processor is further configured to use a set of backspin profiles to detect a failure, event, or condition associated with the pump system or a condition of a fluid associated with the pump system.

13. The system for monitoring of claim 10, wherein the pump system comprises an electric submersible pump or progressive cavity pump.

14. The system for monitoring of claim 12, wherein the processor is further configured to adjust operation of the electric submersible pump system upon detecting the event, condition, or fault.

15. The system for monitoring of claim 10, wherein the processor is part of a pump system controller.

16. The system for monitoring of claim 10, wherein the processor is part of a remote server.

17. The system for monitoring of claim 10, wherein the pump system comprises an electric submersible pump and the parameter comprises one or more of the group consisting of: a drive frequency of the electric submersible pump, a motor current of the electric submersible pump, a discharge pressure of the electric submersible pump, an intake pressure of the electric submersible pump, a motor temperature of the electric submersible pump, an intake temperature of the electric submersible pump, a well head pressure, and one or more current parameters of a gauge of the electric submersible pump.

18. A non-transitory computer-readable medium containing instructions that, when executed by a processor, cause the processor to:
determine a backspin speed occurring during a backspin operation of a pump system; and
provide a backspin profile using the backspin speed.

19. The non-transitory computer-readable medium of claim 18, wherein the instructions further cause the processor to detect a failure, event, or condition associated with the pump system or a condition of a fluid associated with the pump system using the backspin profile.

20. The non-transitory computer-readable medium of claim 19, wherein the instructions further cause the processor to adjust operation of the pump system upon detecting the event, condition, or failure.
